(19) United States
(12) Patent Application Publication
(10) Pub. No.: US 2015/0248687 A1
(43) Pub. Date: Sep. 3, 2015

(54) SYSTEMS AND METHODS TO ENHANCE THE EFFECTIVENESS OF INTERNET ADVERTISING

(71) Applicant: CAFLO GAMES, INC., Tampa, FL (US)

(72) Inventors: John E. Haines, Tampa, FL (US); Philip J. Witte, Salem, OR (US)

(73) Assignee: CAFLO GAMES, INC., Tampa, FL (US)

(21) Appl. No.: 14/633,105

(22) Filed: Feb. 26, 2015

Related U.S. Application Data
(60) Provisional application No. 61/946,787, filed on Mar. 1, 2014.

(51) Int. Cl. G06Q 30/02

(52) U.S. Cl. CPC G06Q 30/0209; G06Q 30/0277

(57) ABSTRACT

Systems and methods are provided to increase the value of the space allocated to a banner advertisement space on a web site by linking it into a larger space, which may be occupied by a game, exposing the user to messages from many advertisers instead of a single merchant on the original banner advertisement space. By providing a balance of risk greed, skill, and reward, end-users become incentivized to play a game repeatedly as they develop their own strategy about how to maximize their score. Throughout the playing of a game, the logos or other identifying images of one or more advertisers deliver many impressions to an end-user, and each advertiser has a high likelihood of an intentional, rather than unintentional, click-through to its web site, social media page, or similar form or format for presenting advertising messages and increased end-user awareness of advertising content.

### CROSS-REFERENCES TO RELATED APPLICATIONS

This application claims the benefit of U.S. Provisional Application No. 61/946,787, filed 1 Mar. 2014.

### STATEMENT REGARDING FEDERALLY SPONSORED RESEARCH OR DEVELOPMENT

Not applicable.

### MICROFICHE APPENDIX

Not applicable.

### DESCRIPTION

1. Field of Technology

At least some embodiments disclosed herein relate, in general, to systems and methods for providing to end-users (also referred to herein simply as ‘users’) information relating to businesses or other commercial or non-commercial information-sources by motivating end-users to access and spend time perceiving advertisements, such as Internet-based games that increase the awareness of advertising messages by incentivizing players to visit and spend time viewing advertisements as a component of playing the games.

2. Background

The Internet has long been used to deliver information relating to businesses to end-users. Such information includes, among other things, directory information relating to products and services such as, for example, advertisements of various types.

The transition from traditional advertising to Internet-based advertising has proved challenging for advertisers. Everyone believes that there is value in the new medium, but applying traditional measurements such as CPM (cost per thousand) for impressions does not yield comparable results. Click-through-rates (CTRs) are limited in their ability to measure the success of an online advertising campaign for a particular website. ‘Clicks’—depressing a computer mouse button when a computer screen cursor is over a hyperlink ('hyperlink portal' or ‘link’) appearing graphically as an advertisement and similar interactions—may bring premium charges against an advertiser, but many clicks are accidental and of little value to the advertiser. End-users have learned to ignore banner ads and some have even learned to use applications which can remove those banner ads from their view. Such ads are widely considered to be a nuisance.

On a typical commercial web site there will often be one or more banner ads prominently displayed. The site owner will either sell that ad space to a local customer or will contract with a third party to sell it for them. The owner will be paid for impressions, plus a premium charge for clicks. Clicking a banner ad may execute a link to the advertiser's page for further information, but a majority of the time such clicks may be by accident. Each of those accidental clicks may cause premium charges to be billed, but deliver no value to the advertiser. The Internet has a great deal of potential for targeted ads which can reach exactly the right kind of buyer at exactly the right time, but many ads are simply presented to anonymous end-users who have no interest in anything on the originating web page except the primary information for which they were looking.

Almost all web site advertising follows this same approach. While there is some satisfaction in being with the rest of the crowd, this technique of presenting banner ads to anonymous end-users misses the unique value that the Internet brings. It is done this way, even though it is ineffective, simply because no one has come up with a better idea.

### BRIEF DESCRIPTION OF THE SEVERAL VIEWS OF THE DRAWINGS

The embodiments illustrated are by way of example and not limitation in the figures of the accompanying drawings in which like references indicate similar elements.

FIG. 1 is a conceptual mock-up of an exemplary web page into which one or more embodiments of an Internet-based game may be implemented in lieu of a banner advertisement.

FIG. 2 illustrates one possible game board for an embodiment utilizing one possible form of Internet-based game.

FIG. 3 is a conceptual mock-up of an advertiser's web page in the content of which a game token hyperlink has been placed for discovery by an end-user playing an Internet-based game.

FIG. 4 presents a conceptual illustration of the operation of various embodiments of the systems and methods of the present disclosure.

FIG. 5 illustrates a high-level overview of an advertising service provider and a network configuration through which the provider interacts with end-users and individuals or entities that provide products and services.

FIG. 6 shows a block diagram of a data processing system that can be used in various embodiments of the disclosed systems and methods.

FIG. 7 shows a block diagram of an end-user device according to one embodiment of the disclosed systems and methods.

FIG. 8 is a flow chart showing one particular method for incentivizing end-users to visit and spend time viewing advertisers' web sites.

### DETAILED DESCRIPTION OF THE INVENTION

The following description and drawings are illustrative and are not to be construed as limiting. Numerous specific details are described to provide a thorough understanding. However, in certain instances, well-known or conventional details are not described in order to avoid obscuring the description. References to “one embodiment” or “an embodiment” in the present disclosure are not necessarily references to the same embodiment; and, such references mean at least one.

Reference in this specification to “one embodiment” or “an embodiment” or “a particular embodiment” means that a particular feature, structure, or characteristic described in connection with the embodiment is included in at least one embodiment of the disclosure. The appearances of the phrase ‘in one embodiment’ or substantially similar phrases in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Various embodiments of the systems and methods disclosed herein are calculated to cause an end-user to accept willingly advertisements as a focus of his or her attention. Certain embodiments comprise one or more Internet-based games that increase the awareness of advertising messages by incentivizing players to visit and spend time viewing advertisers' web sites as a component of playing the games.

The terms ‘user’ and ‘end-user’ are used interchangeably herein.

For the purpose of the present disclosure, the ten ‘advertisement’ should be understood to refer to any type of electronic information that a business or other commercial or non-commercial information-source directs to end-users in order to, among other things, solicit such end-users business, educate or inform end-users, or prompt end-users to take some kind of action. Such information could comprise, for example, directory listings for a business on an online directory service, or coupons, advertisements or promotions for a business on an electronic advertising, service.

One or more embodiments that can serve to increase the value of the space allocated to a banner advertisement space on a web site by linking it into a larger space, which may be by way of a game board interface, exposing the user to messages from many advertisers instead of a single merchant on the original banner advertisement space. A game-based approach to an embodiment can be implemented in many different ways, utilizing many different game types, including, but not limited to, board games such as tic tac toe, checkers, chess, backgammon, reverse, etc. Game-based embodiments could be designed in which users compete against one another, either synchronously or asynchronously, for incentives.

A single advertiser's web site could present a plurality of different products or features of products in a game. By way of illustration, and not limitation, a car manufacturer could present five different automobile models and show five different colors of each model, or a restaurant could present multiple menu items. In the course of playing a game, a user could be exposed to many more combinations than he or she would be likely to see simply by browsing through the advertiser's web site.

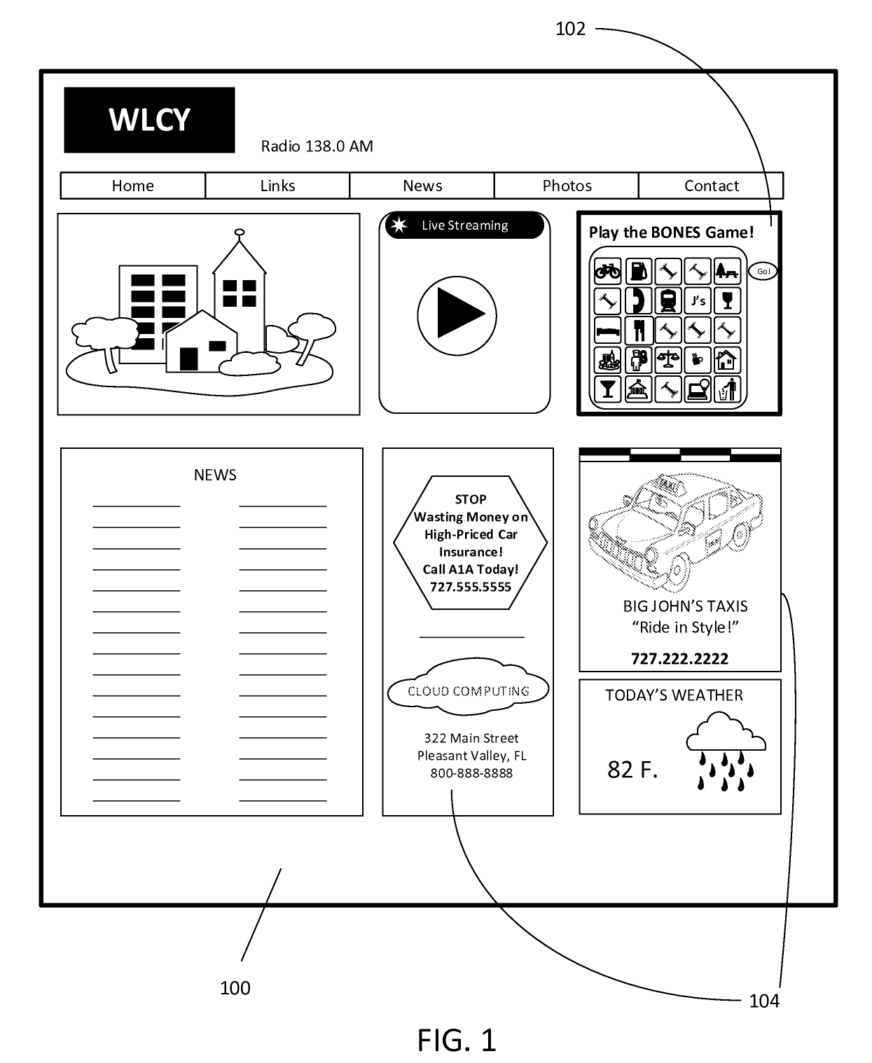

FIG. 1 is a conceptual mock-up of an originating web page 100 into which one or more embodiments of an Internet-based game may be implemented and hosted in lieu of a banner advertisement 104. In a particular embodiment, a hyperlink portal to a game board 102 replaces a banner advertisement 104 with a plurality of new display advertisement positions that may be sold to one or more advertisers. Additional banner advertisements 104 could still be placed on the same web page, and the increased user traffic that a given embodiment brings to the site thereby can serve to increase user impressions and clicks with respect to those additional banner advertisements 104, and hence, greater potential advertising effectiveness for the advertisers, as well as greater potential revenues for the web site charging the advertisers to display the advertisements.

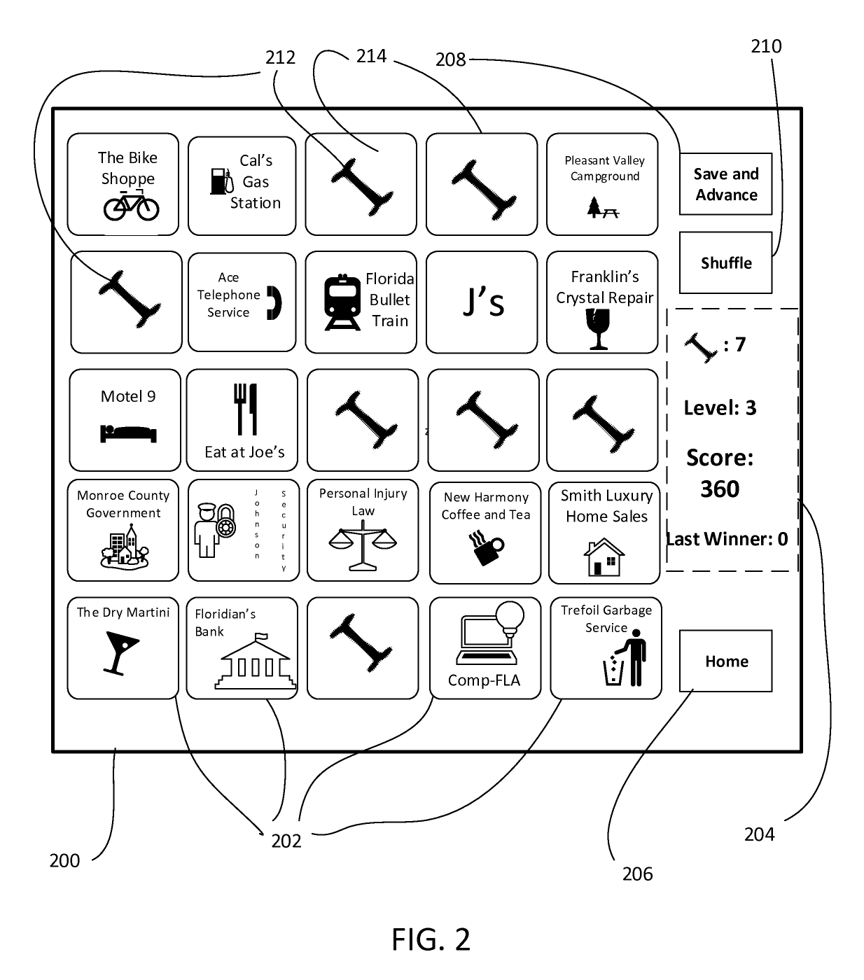

FIG. 2 illustrates one possible design of a game board 200 for an embodiment utilizing one form of Internet-based game. In this particular embodiment, a plurality of advertisers or product options may be presented to an end-user in the form of a game board 200 with illustrated tiles 202 laid out in a grid pattern, each of which initially may identify a given advertiser or product option on the game board 200, and each of which could be an advertising hyperlink (i.e., a hyperlink to a target) which, by way of example and not limitation, could be a web site, social media page, or electronic visual, audio, or audio-visual file or format on which advertisements or other information resides. During the course of play, the illustrated tiles 202 could change to identify other advertisers, or to display one or more graphical objects representing a game token 212, e.g., as an illustration of a bone.

Playing a game could involve an end-user clicking on an illustrated tile 202 associated with an advertiser on the game board 200, representing a link to that advertiser's advertisement, which advertisement could be presented in the form of, by way of example and not limitation, a web site, a social media page, or other visual, audio, or audio-visual file or format. Play could further involve taking some action with respect to a target advertisement, for the purpose of progressing in or winning a game, which would cause the end-user to focus attention on advertising content. By way of example, but not limitation, the rules of a game might cause an end-user to enter into an online chat with an advertising representative, or answer a quiz about an advertiser or its products or services, or spend time perusing advertising content on an advertiser's web site or social media page.

In one game-based embodiment, an end-user playing a game would be required to search on an advertiser's website for a game token hyperlink (a hyperlink representing a game token), which may be associated with a graphical object representing a game token 212, such as an illustration of a bone, placed discreetly within the content of an advertiser's web site. Activation of a game token hyperlink by an end-user might then be reflected on the game board 200 by the replacement of an illustrated tile 202 that originally had identified said advertiser with a token tile 214 bearing a graphical object representing a game token 212. A game could include a scoreboard 204 as well as clickable buttons 206, 208, 210 to carry out game-related functions such as returning to an originating web page 100 via a home button 206, saving the current configuration of a game or a game board 200, and advancing play via a save and advance button 208, or randomly shuffling the configuration of a game board 200 via a shuffle button 210 as a potential means of improving the player's score.

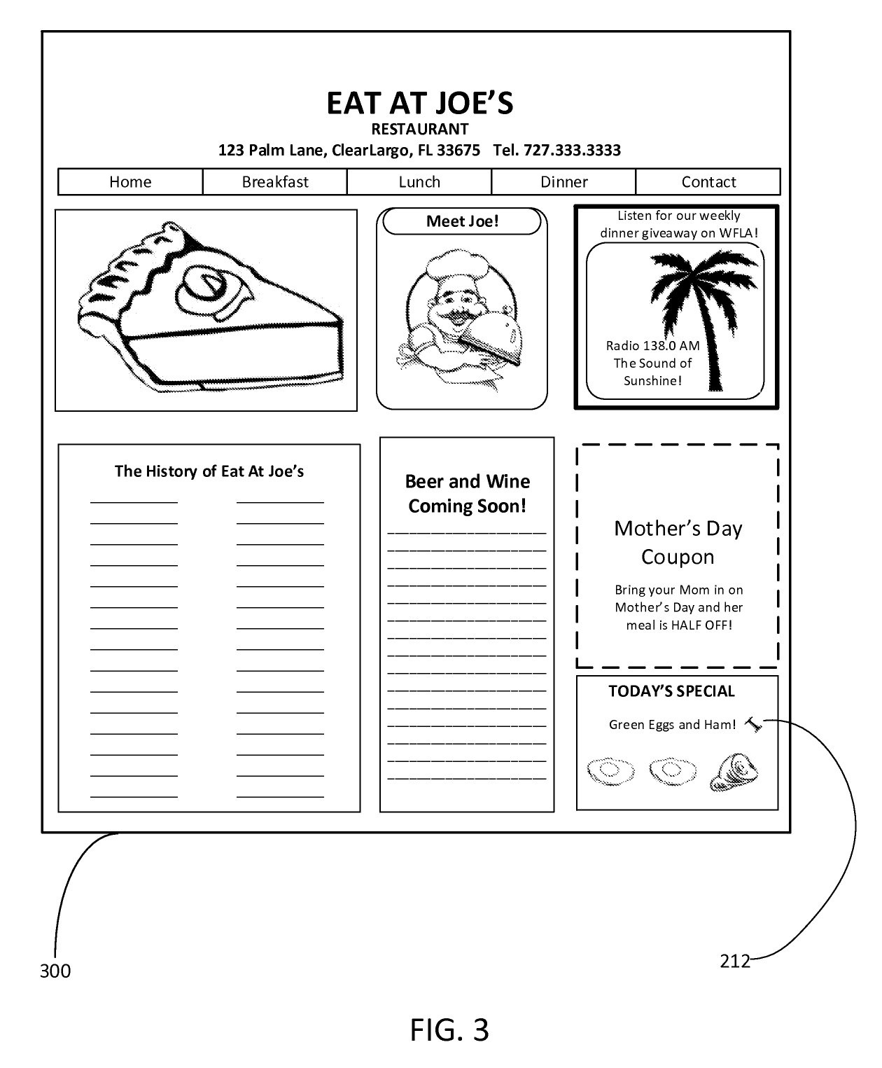

FIG. 3 is a conceptual mock-up of an exemplary target advertisement 300 of an advertiser, in this example a web page, into the content of which a graphical object representing a game token 212, said graphical object here being an illustration of a bone, has been placed for discovery by an end-user playing an Internet-based game. Having been directed to that advertiser's target advertisement 300 by having clicked on an illustrated tile 202 identifying the advertiser on a game board 200, the end-user could be exposed to more detail about the advertiser or its products and services than presented by the illustrated tile 202 alone as he or she searches for a graphical object representing a game token 212. The end-user may receive credit or advance in a game when he or she activates a game token hyperlink by clicking on a graphical object representing a game token 212 on the target advertisement 300, returning the end-user to a game board 200. The advertiser could associate a game token hyperlink to a graphical object representing a game token 212, as illustrated in FIG. 2. Whether associated with a graphical object representing a game token 212, however, a game token hyperlink could be placed at a strategic location on an advertiser's web page, social media page, or other form of target advertisement so as to draw the attention of the end-user to the advertiser's most important content or message. Whenever an end-user were to locate a game token hyperlink on a target advertisement 300, a token tile 214 could be added to a game board 200 in place of an illustrated tile 202 originally identifying that advertiser, thereby updating a game board 200 and rewarding the end-user by allowing the end-user to progress in, or win, a game.

In a game-based embodiment, a scoring system could be used to measure the success of the end-user in advancing through a game. Players generally could be rewarded with advancement in a game for having gone to a target advertisement and for having taken successfully a desired action, such as clicking on a game token hyperlink, resulting in an update to a game ('game update' or ‘updated game’). Furthermore, to introduce an element of risk, players could be rewarded or punished for advancement. By way of illustration, but not limitation, if an object of the game were to achieve a single row, column, or diagonal line of token tiles 214 on a game board 200, such as in tic tac toe, then following the successful location of a game token hyperlink on a target advertisement 300, illustrated tiles 202 comprising a game board 200 could be randomly rearranged or shuffled into a new pattern that could be advantageous or disadvantageous to this objective, thereby inserting an element of risk to play. Any scoring system may be particularly effective, not only when the end-user playing a game is motivated to take risks in the way he or she plays the game in order to earn a higher score, but also when it includes the possibility of a penalty to the score if too much risk is taken. End-users could complete a plurality of levels of play, resulting, for example, in new patterns of illustrated tiles 202 for each level attained.

In embodiments based on Internet-games, a set of rules for a game may include one or more incentives to the end-user for having achieved a high score. This incentive may simply be a display of how his or her score compares to his or her personal best, or how his or her score ranks compared to other end-users. As end-users play a game, which may be designed for ease of play, they could accumulate a score that could qualify them automatically to win or compete for material incentives, such as a monetary or product or service prize offered by an advertiser or a web site hosting a game, the cost of which might be covered by additional advertising revenues or sales resulting from the game itself.

By providing a balance of risk greed, skill, and reward, then, end-users become incentivized to play a game repeatedly as they develop their own strategy about how to maximize their score. Throughout the playing of a game, the logos of one or more advertisers or other identifying images deliver many impressions to an end-user, and each advertiser has a high likelihood of an intentional, rather than unintentional, click-through to its web site, social media pages, or other form or format of presenting advertisements, and generating increased end-user awareness of the advertisements.

Using existing technology well-known in the art, an attempt may be made to target specific advertisements to a particular end-user based on his or her most recent Internet browsing history or search terms used in browsing. “Cookies” may be used to help facilitate this.

End-users could be expected to register willingly to play a game, though the volume of registrations could be enhanced through the offering of incentives, material or otherwise. Registration, at a minimum, could include an e-mail address so that the prize could be delivered or the winning end-user notified about it. During the course of registration, data could be collected directly as to the individual end-user's preferences while maintaining his or her privacy. Additionally, data could be collected by presenting the end-user with a different type of game board from time to time during the course of play that would be specifically designed to collect end-user preference data and to generate inferences as to the demographics of the end-user, such as age and income level. In these ways, among others, such as collaborative filtering, advertisements can be better targeted within the scope of a game.

The advertising environment may be enhanced further by one or more of at least three factors for dynamically selecting which merchants to place onto a particular game board. One such factor could be demographic matching between a player and an advertiser. For example a beauty salon might not want to be presented to males, or a preschool might not want to be presented to senior citizens.

A second factor, based on available advertising funds, could be used to manage advertising expense within a monthly budget. An advertiser's logo or other identification might only placed as an graphic image on an illustrated tile 202 on a game board 200 while unused funds remain on deposit with a game host during a given budget period. When the advertiser's funds have been exhausted, the advertiser would not appear on a game board 200 until its next budget period and the advertising charges would stop automatically in the interim.

A third factor could be an established time frame for an advertising campaign. A game format may easily allow for beginning and ending a campaign on specific dates. This is very useful for promoting a particular sale or event.

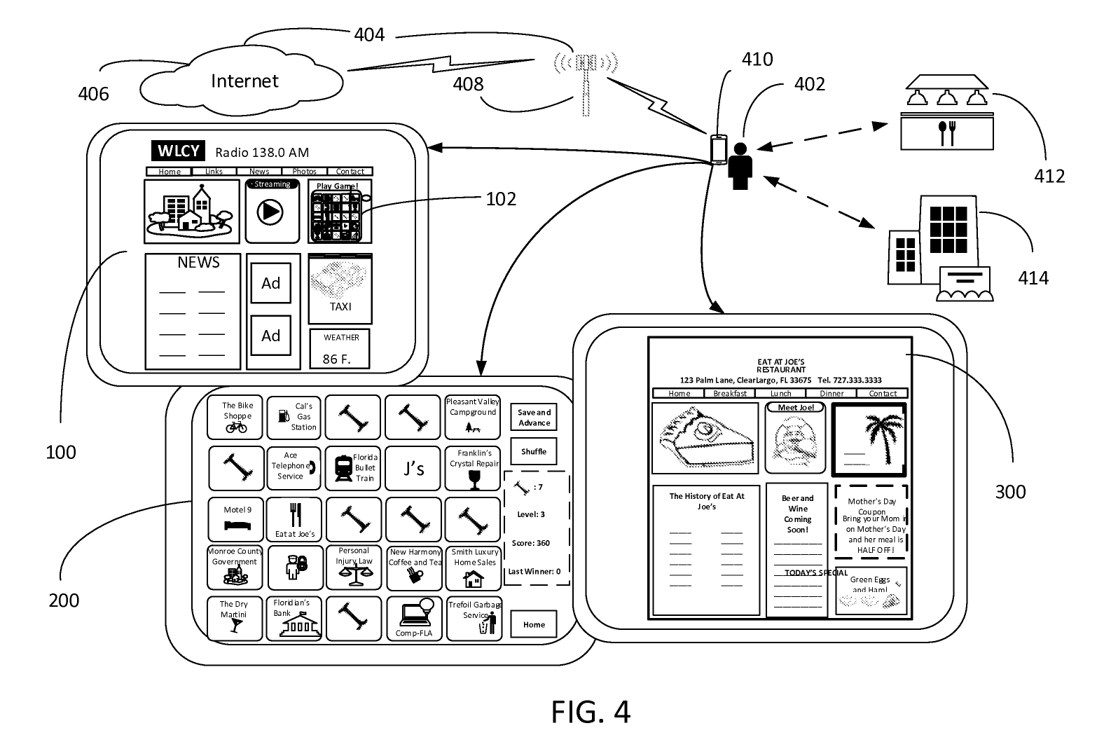

FIG. 4 presents a conceptual illustration of the operation of various embodiments of the systems and methods of the present disclosure. An end-user 402 is linked to one or more a communications networks 404 such as the Internet 406 or a mobile communications network 408 or both via an end-user's device 410, in this case, a smart phone, such as an Apple iPhone or cellular phones utilizing the Android operating system. The communications network 404 can be any type of communications network, including, but not limited to, the World Wide Web of the Internet 406. A device 410 can be any type of device capable of communicating with the communication network 404 such as, without limitation, desktop computers, laptop computers, tablet computers, cell phones, smart phones, and PDAs. In various embodiments, the communications network(s) 404 provide(s) voice and messaging capabilities and may provide access to other networks.

The end-user 402 may interact with a device 410 in a variety of ways including, without limitation, sending and receiving voice and text messages, sending and receiving emails, searching for subject matter using Internet-based search and/or directory services and a variety of applications hosted by the device 410. In so interacting with a device 410, an end-user 402 may receive data, including advertisements, and broadcast data relating to the identity of the end-user 402 and his or her interests, preferences, and online activities over the communications network 404. Interests and preferences of an end-user 402 may either be gleaned indirectly from his or her online activities, or be expressly defined by the end-user 402. In an embodiment, the end-user 402 may define such interests and preferences in a list of categories of interest.

In an Internet game-based embodiment, an end-user 402 may access and play an Internet-based game using a web browser or a special purpose application on a device 410. Thus, by way of example but not limitation, if a local radio station acting an advertising service provider 414 were to host a game on or through an originating web page 100, then using a device 410, an end-user 402 could type into a browser on a device 410 the URL of the originating web page 100, or click on a hyperlink to the originating web page 100, or activate a special purpose application on the device 410 in order to transmit a request to a server to transmit the originating web page 100 to the device 410 of the end-user 402 for display thereon. As illustrated in an embodiment represented in FIG. 1, an originating web page 100 initially transmitted and displayed to an end-user 402, in addition to other content, could contain a hyperlink portal 102 to a game board 200 on which the end-user 402 would be required to click in order to display a game board 200 on a device 410 and begin playing a game. In another embodiment, a game board 200 itself could be transmitted initially to and displayed on the device 410 of the end-user 402, allowing an end-user 402 to begin playing a game immediately.

In an embodiment illustrated in FIG. 4, in playing a game, an end-user 402 may click on a hyperlink representing an advertiser, said hyperlink appearing as an illustrated tile 202 bearing a logo or other unique identifying information of an advertiser 412 on a game board 200, and in response, the target advertisement 300 of the advertiser 412 is displayed on the device 410 of the end-user 402, exposing the end-user 402 to impressions of the content on the target advertisement 300 as he or she attempts to take an action or actions required to continue playing the game or to score, or both. In such an embodiment, an advertiser 412 may pay a fee to an advertising service provider 414 hosting a game in order to have a hyperlink to a target advertisement 300 of the advertiser 412 included as a component of playing a game.

In an embodiment, in order to continue playing a game or to score, or both, an end-user 402 searches for a game token hyperlink on a target advertisement 300 displayed in response to the end-user 402 having clicked on a hyperlink associated with an illustrated the 202 on a game board 200 in the course of playing a game. In an embodiment, before being so-redirected and without any additional action on the part of the end-user 402, additional information regarding a special offer may be displayed to an end-user 402, or an end-user 402 may be prompted to provide information, or both.

Advertisements could take any format known in the art suitable for displaying advertisements on a device 410 of an end-user 402 such as, by way of illustration and not limitation, a text abstract for a business, text and graphics describing the business, or multimedia tiles describing the business. In various embodiments, an advertisement could include any type of information relating to a business such as, for example, sales, deals or promotions offered by the business.

In an embodiment, the advertisements referenced in the examples may originate from an advertising service provider 414 that provides the advertisements to the end-user 402 via the communications network(s) 404. In various embodiments, the advertising service provider 414 could be any electronic service provider that maintains it relating to the advertising activities of an advertiser 412.

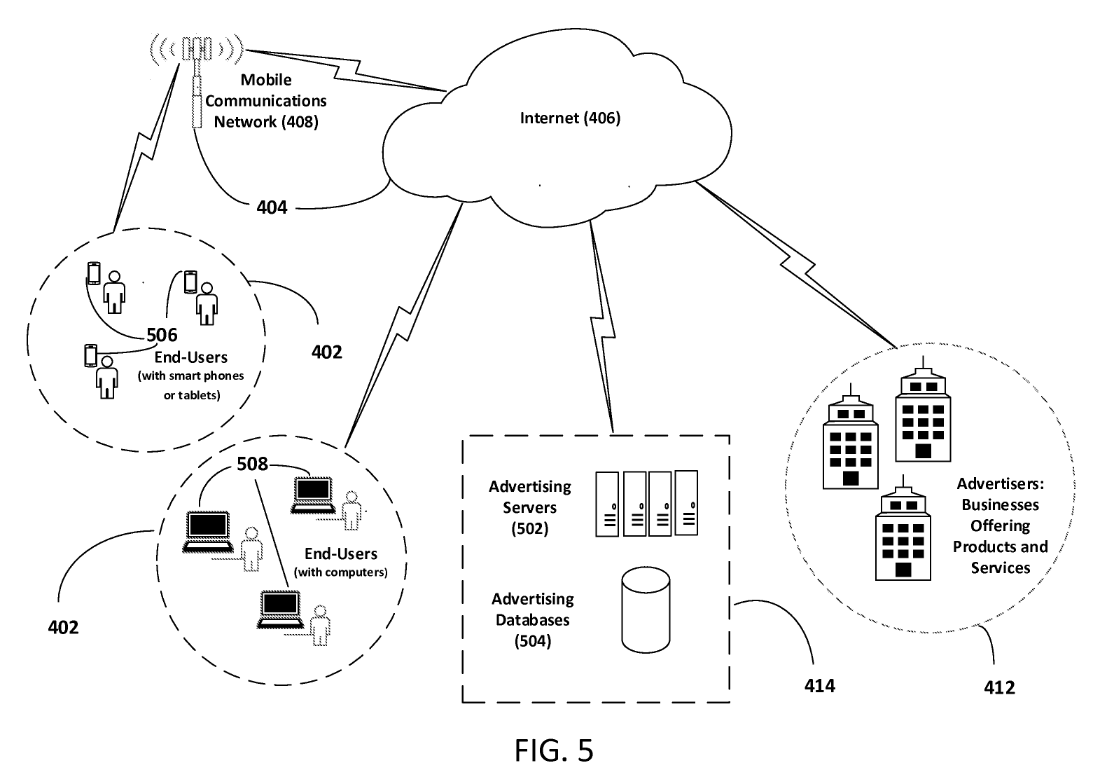

FIG. 5 illustrates an embodiment of a high-level overview of an advertising service provider 414 and a particular network configuration through which the advertising service provider 414 interacts with end-users 402, as well as advertisers 412, including businesses that provide products and services. By typing into a browser on a device 410 the URL of the web page 100, or by clicking on a hyperlink to that web page 100 using a device 410, or by activating a special purpose application on a device 410, an end-user 402 accesses a game by transmitting a request to an advertising server 502 to transmit the web page 100 for display on the device 410.

Various services relating to the implementation of a game could also be divided between multiple service providers. In the illustrated embodiment, a number of advertisers 412, businesses offering products or services, or both, wish to advertise to end-users 402 of a communications network 404 that may have an interest in the products or services, or both, of the businesses.

In an embodiment, advertisers 412 such as businesses communicate advertisements to an advertising service provider 414 by any conventional means such as, by way of illustration and not limitation, the Internet, via email or a website provided by the advertising service provider 414, by voice message or text message, and so forth. Each advertisement comprises advertisement details that are presented to end-users 402 viewing the advertisement using their respective devices 410. In various embodiments, advertisement details can specify any type of advertisement such as, for example, directory listings, coupons, offers, promotion or any other type of information relating to a business that can be delivered to devices 410 of the end-users 402.

In an embodiment, data relating to advertisements are stored and updated on one or more advertising databases 502 maintained by the advertising service provider 414 via facilities hosted on one or more advertising servers 504. Such advertisements could take the form of, by way of illustration and without limitation, text objects, HTML objects, media objects, voice messages and text messages, and could be communicated to the devices 410 of the end-users 402 via any available means such as, for example, Internet 406 or any facilities provided by any other communications network 404, such as a mobile communications network 408, or by any combination of such communications networks 404.

In an embodiment, facilities hosted on the advertising servers 502 may obtain data relating to the end-users 402 and the interactions of the end-users 402 with their devices 410 via the communications network(s) 404. The advertising servers 502 may archive historical information on the advertising databases 504 relating to the interactions of end-users 402 with their devices 410 over time. In the embodiment illustrated in FIG. 5, some devices 402 are mobile phones 506, while others are desktop computers 508.

In an embodiment, the communications network provides data relating to end-users 402 of the communications network 404 to an advertising service provider 414 on a periodic or continuous basis. In an embodiment, end-users 402 may register explicitly with an advertising service provider 414 and the communications network 404 will provide data relating end-users 402 who have registered only to the advertising service provider 414. In an embodiment, end-users 402 may register with the advertising service provider 414 and maintain various types of profile information stored on the advertising databases 504 via facilities provided by the advertising servers 502 such as, for example, a website.

In an embodiment, the facilities hosted on the advertising servers 502 may provide facilities to enable end-users 402 to maintain one or more lists of categories of interest to the end-users 402. For example, the facilities hosted on the advertising servers 502 could provide an interface on the device 410 of an end-user 402 to allow the end-user 402 to create, edit and delete lists of categories of interest to the end-user 402. In an embodiment, a given end-user 402 may create and maintain one or more lists of categories of interest, where each list is relevant to a context of the end-user 402. Such lists could be utilized by an advertising service provider 414 to design games or game boards directed to end-users 402 likely to be interested in the good or services, or both, of select advertisers 412.

In an embodiment, additionally or alternatively, the facilities hosted on advertising servers 502 automatically identify categories of interest to end-users 402 from the data relating to the interactions of the end-users 402 with their devices 410 and create or update, or both, lists of categories of interest and preference for such end-users 402. In an embodiment, categories may be inferred from text entered by end-users 402 into messages and/or search queries sent from the devices 410 of end-users 402 using any textual, linguistic or semantic technique known in the art, for example, parsing and identifying keywords, key phrases and other textual signals within such text. In an embodiment, categories of interest to end-users 402 are, additionally or alternative, inferred from other any other actions of an end-user 402 that do not relate to text entry, such as, for example, selection by an end-user 402 of specific websites or directory entries.

In an embodiment, historical and informational data relating to end-users 402 are used to infer categories of interest to end-users 402. In an embodiment, historical and informational data relating to end-users 402 is used to create lists of categories for multiple user contexts. Such contexts can relate to, without limitation, the location, a date, days of the week, time of day and/or social context (e.g. in the company of family or friends) of the end-user 402.

In an embodiment, end-users 402 playing a game that may use facilities hosted on one or more advertising servers 502 may click on hyperlinks to advertisers 412, which hyperlinks may be represented as illustrated tiles 202 or other graphical objects bearing the logo or other unique identification of an advertiser 412 on a game board 200. During the course of playing the game end-users 402 may be presented with targeted advertisements 300 for those advertisers 412, which end-users 402 must examine carefully in order to take any action required to continue playing and progress in the game. By way of example, but not limitation, an end-user 402 could be required to find and click on a game token hyperlink—in an embodiment presented in FIG. 3, the game token hyperlink is presented as a graphical object representing a game token 212, being in this example an illustration of a bone—on a target advertisement 300, allowing an end-user 402 to return to the game board 200 and continue playing and progress further in the game.

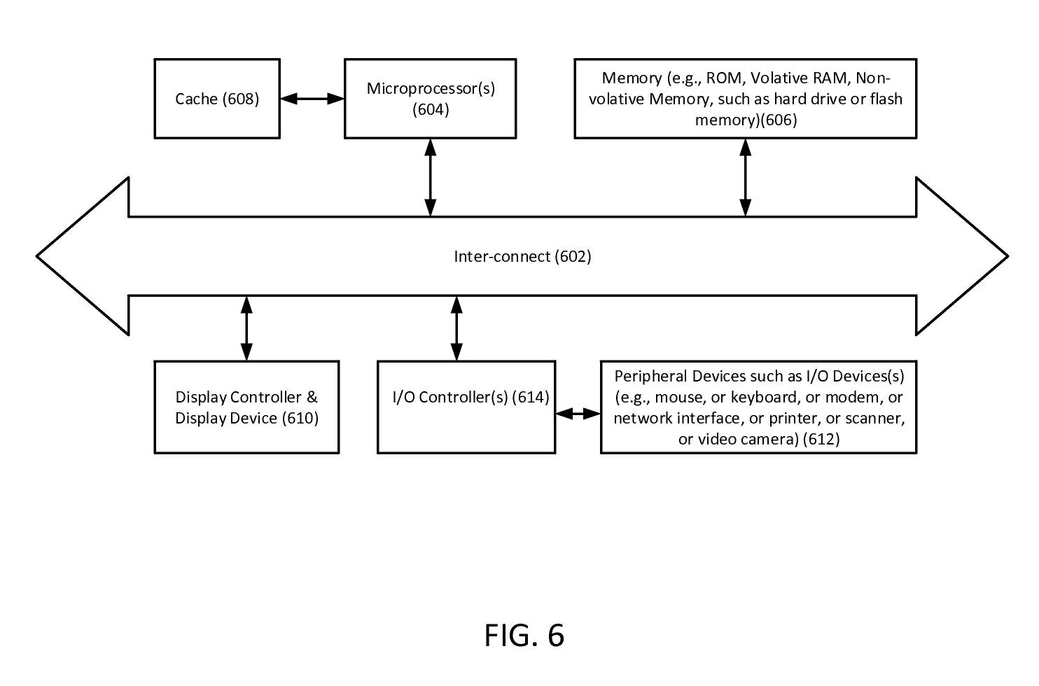

FIG. 6 shows a block diagram of a data processing system that can be used in various embodiments of the disclosed systems and methods. While FIG. 6 illustrates various components of a computer system, it is not intended to represent any particular architecture or manner of interconnecting the components. Other systems that have fewer or more components may also be used.

In FIG. 6, the system includes an inter-connect 602 (e.g., bus and system core logic), which interconnects one or more microprocessor(s) 604 and memory elements 606. A microprocessor 604 is coupled to cache memory 608 in the example of FIG. 6.

The inter-connect interconnects the microprocessor(s) 604 and the memory 606 together and also interconnects them to a display controller and display device 610 and to peripheral devices 612 such as input/output (I/O) devices through one or more input/output controllers 614. Typical I/O devices include, without limitation, mice, keyboards, modems, network interfaces, printers, scanners, video cameras and other devices that are well-known in the art.

The inter-connect may include one or more buses connected to one another through various bridges, controllers and/or adapters. In one embodiment the I/O controller includes a USB (Universal Serial Bus) adapter for controlling USB peripherals, and/or an IEEE-1394 bus adapter for controlling IEEE 1394 peripherals.

The memory 606 may include ROM (Read-Only Memory), and volatile RAM (Random Access Memory) and non-volatile memory, such as hard drive, flash memory, etc. Volatile RAM is typically implemented as dynamic RAM (DRAM) that requires power continually in order to refresh or maintain the data in the memory. Non-volatile memory is typically a magnetic hard drive, a magnetic optical drive, or an optical drive (e.g., a DVD RAM), or other type of memory system that maintains data even after power is removed from the system. The non-volatile memory may also be a random access memory. The non-volatile memory can be a local device coupled directly to the rest of the components in the data processing system. A non-volatile memory that is remote from the system, such as a network storage device coupled to the data processing system through a network interface such as a modem or Ethernet interface, can also be used.

In an embodiment, the advertising servers of FIG. 5 may be implemented using one or more data processing systems as illustrated in FIG. 6. In an embodiment, devices 410 of end-users 402 such as the mobile phones 506 represented as 410 in FIG. 4 and as 506 in FIG. 5 are implemented using one or more data processing systems as illustrated in FIG. 6.

In some embodiments, one or more servers of the system illustrated in FIG. 6 are replaced with the service of a peer-to-peer network or a cloud configuration of a plurality of data processing systems, or a network of distributed computing systems. The peer-to-peer network, or cloud based server system, can be collectively viewed as a server data processing system.

Embodiments of the disclosure can be implemented via the microprocessor(s) 604 and/or the memory 606. For example, the functionalities described above can be partially implemented via hardware logic in the microprocessor(s) 604 and partially using the instructions stored in the memory 606. Some embodiments are implemented using the microprocessor(s) 604 without additional instructions stored in the memory 606. Sonic embodiments are implemented using the instructions stored in the memory 606 for execution by one or more general-purpose microprocessor(s) 604. Thus, the disclosure is not limited to a specific configuration of hardware and/or software.

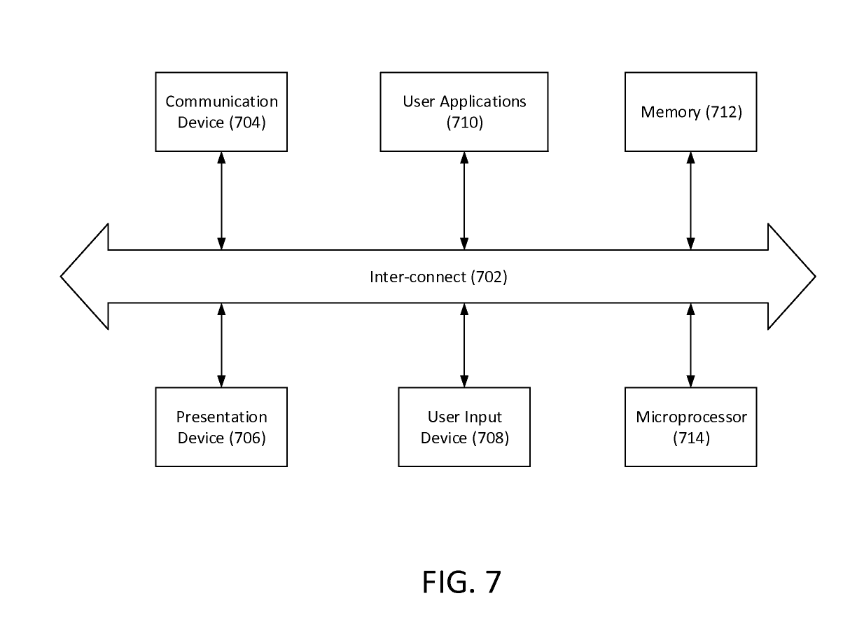

FIG. 7 shows a block diagram of a device 410 of an end-user 402, such as the devices 410, 506, 508 presented in FIG. 4 and FIG. 5 according to one embodiment. In FIG. 7, a device 410 includes an inter-connect 702 connecting a communication device 704, such as a network interface device, a presentation device 706, such as a display screen, a user input device 708, such as a keyboard, mouse, or touch screen, user applications 710 implemented as hardware, software, firmware or a combination of any of such media, such various user applications (e.g. apps), a memory 712, such as RAM or magnetic storage, and a microprocessor 714 which, inter aria, executes the user applications.

In one embodiment, the user applications 710 implement one or more user interfaces displayed on the device 410 of the end-user 402 that provides end-users 402 the capabilities to, for example, access the Internet 406, send and receive messages and/or receive and display advertisements transmitted by an advertising service provider 414 such as that presented in FIG. 4 and FIG. 5.

In one embodiment, end-users 402 employ an end-user input device 610 to interact with the device 410 via the user applications 710 supported by the device 410, for example, by accessing and interacting with websites, messages and advertisements described in detail above with respect to FIG. 6 and FIG. 7. The end-user input device may include, by way of illustration and not limitation, a text input device, a still image camera, a video camera, and/or a sound recorder, etc.

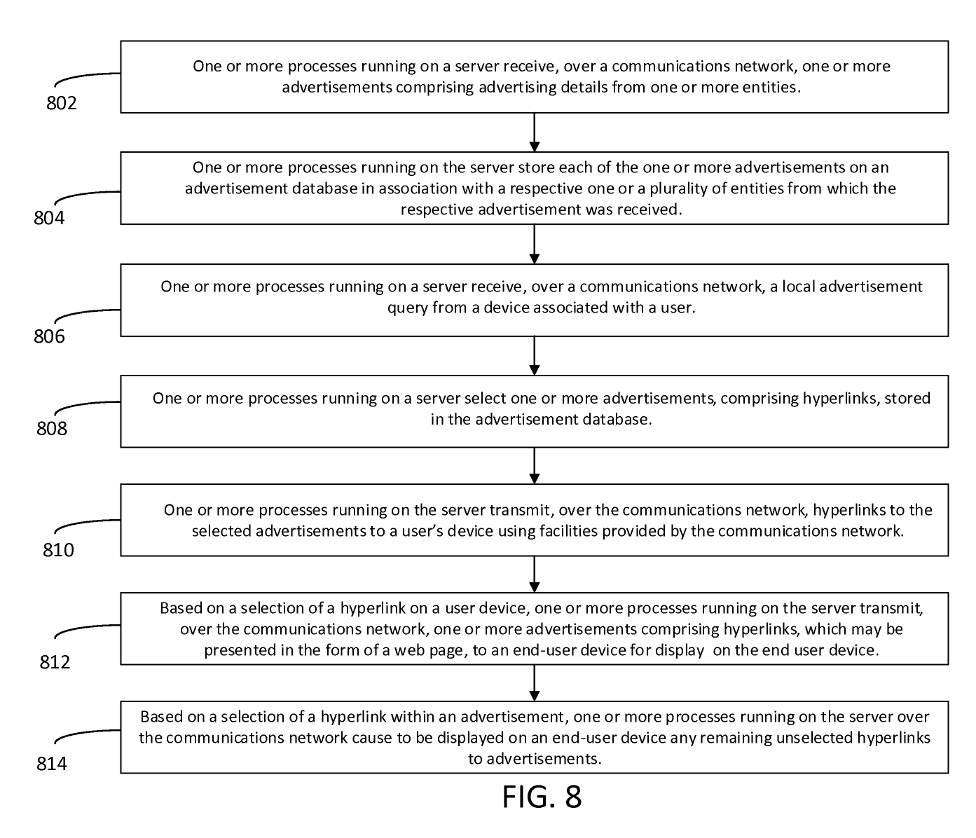

FIG. 8 shows a method for delivering advertisements to an end-user 402 as a component of playing an online game that may relate to the interests and preferences of the end-user 402. In one embodiment, one or more servers such as the advertising servers 502 shown in FIG. 5 perform the operations of the method shown in FIG. 8, and the advertising databases 504 represented in FIG. 5 store the data collected and stored by the method.

In the first operation of the method 802, one or more processes running on a server receive, over a communications network, one or more advertisements from one or more entities. Each advertisement comprises advertisement details. In an embodiment, advertisement details can provide data relating to any type of advertisement such as, by way of example and not limitation, directory listings, coupons, offers and promotions.

Advertising details can be expresses in any format such as, by way of example and not limitation, text objects and multimedia objects such as images, audio files or audiovisual data, or both. In an embodiment, advertisement details could include one or more of the following fields: a description of an entity associated with an advertisement; a description of a product, brand, or service associated with the advertisement; a description of a coupon, offer, or promotion associated with an advertisement; freeform text relating to any matter; temporal criteria, such as dates, times, or days of the week, or some combination of any of these, that the advertisement is active.

In an embodiment, advertisement categories are categories to which the advertisement relates. In various embodiments, advertisement categories could relate to any topic of potential interest to a user. By way of example and not limitation, such categories could include such broad topics as food, automobiles, health, travel. In an embodiment, such categories could include additionally, or in the alternative, narrower topics such as pizza, hamburgers, tacos, or a specific restaurant; Chevrolets, Volkswagens, Ferraris, or a specific automobile dealership; pharmacies, or a specific pharmacy; hotels or a specific hotel chain.

In an embodiment, advertisement categories can be expressed in any conventional format known in the art such as, by way of example and not limitation, a text string comprising a key word or a key phrase, a key referring to an entry in a reference database, a symbol, a token or a set of tokens.

In an embodiment, the processes running on a server receive the advertisements via any conventional means known in the art, for example, via a communications network, such as the Internet or an internal network of an advertising service provider, or both. In an embodiment, the processes running on a server receive the advertisements in any format suitable for transmission of electronic data for example, via, text messages, voice messages, text files in any format such as XML, multimedia files, emails and so forth.

In the second operation of the method 804, one or more processes running on the server store each of the one or more advertisements on an advertisement database in association with a respective one of a plurality of entities from which the respective advertisement was received. In an embodiment, the advertisement database can be any type of database now known or later to be developed in the art such as, for example, an object oriented database or a conventional RDBMS. In an embodiment, the advertisements on the database may be indexed by the advertisement's categories and any other relevant fields such as, for example, the starting date and time and the ending date and time for the advertisements.

In the third operation of the method 806, one or more processes running on a server receive, over a communications network, from a device associated with a user, an advertisement query (which query could be, for example, a request to play a game on a device, i.e., a request to a server to transmit to a device of an end-user for display thereon a web page configured as a game board, allowing an end-user to begin playing a game; or a request to a server to transmit to a device of an end-user for display thereon a web page with a hyperlink portal to a web page configured as a game board; or a request to a server to transmit to a device of an end-user for display thereon a web page with a hyperlink associated with a graphical object or otherwise within or among or as advertising content). In an embodiment, the processes running on a server receive the query in any format suitable for transmission of electronic data for example, via text messages, voice messages, text files in any format such as XML, multimedia files, emails and so forth.

In an embodiment of the method, an initial advertisement query comprises, at a minimum, an identification of the user. The identification of the user could comprise any symbol, token or set of tokens that identify the user to the processes running on a server, such as, for example, a user ID on an advertising service or a cell or mobile phone number for the user. In an embodiment, an initial local advertisement query additionally comprises one or more query categories. In various embodiments, query categories could relate to any topic of potential interests to users. In an embodiment, query categories can be expressed in any conventional format known in the art such as, for example, a text string comprising a key word or a key phrase, a key referring to an entry in a reference database, a symbol, a token or set of tokens.

In the fourth operation of the method 808, one or more processes running on a server select one or more advertisements, stored in the advertisement database. Advertisements may be associated with identifying information about the user and/or his or her interests and preferences. Advertisements comprise one or hyperlinks, which may be displayed as graphical objects.

In an embodiment, an advertisement relates to the user's interests where one or more categories associated with the advertisement match one or more query categories specified in the local advertisement query. In an embodiment, an advertisement relates to the user's interests where one or more categories associated with the advertisement match one or more categories in a list of categories associated with the user. In an embodiment, an advertisement relates to the user's interests where one or more categories associated with the advertisement match one or more categories in a list of categories associated with the user and the user's context. In an embodiment, contexts can include, without limitation, information relating to the user's location, a date, days of the week, time of day and social context (e.g. in the company of family or friends).

In an embodiment, where temporal criteria are associated with one or more advertisements and a current time associated with a user's device does not match such temporal criteria, the processes running on the server do not select such advertisements. In an embodiment, such temporal criteria could comprise, for example, dates, times and/or days of the week the advertisement is active.

In the fifth operation of the method 810, one or more processes running on the server transmit, over the communications network, hyperlinks to the selected advertisements to the user's device using facilities provided by the communications network including, without limitation, text messaging, voice messaging and/or multimedia messaging capacities provided by the network. In an embodiment, the user's device receives and displays hyperlinks using the application that issued the advertisement query. In an embodiment, illustrated tiles within a virtual game board displayed on a user's device may represent hyperlinks.

Illustrated tiles representing hyperlinks, displayed to a user, may contain graphics associated with an advertiser, such as a picture of an advertiser's logo. In an embodiment, users' devices receive and display hyperlinks to advertisements by opening an application—which application could be a mobile app, a Java application, or any other application sourced from a suitable platform now known in the art or to be developed in the future—designed for displaying such hyperlinks. Such an application might also have the capacity to display the advertisements related to the hyperlinks. A game-based embodiment may display hyperlinks as tiles or other graphical objects on a virtual game board.

In the sixth operation of the method 812, based on a selection of a hyperlink (such as a game token hyperlink) on a user device, one or more processes running on the server transmit, over the communications network, one or more advertisements, which may be presented on or in the form of a web page, a social media page, or any other visual, audio, or audio-visual file, to an end-user device for display on the end-user device. The one or more advertisements, regardless of the file or format of presentation, comprise hyperlinks. In an embodiment, hyperlinks may be appear as graphical objects such as illustrated tiles. These graphical objects may be identical to, mimic, or relate to objects that have been presented on a game board on a user device.

In the seventh operation of the method 814, based on a selection of a hyperlink (such as a game token hyperlink) within an advertisement, one or more processes running on the server over the communications network cause to be displayed on a user device any remaining unselected hyperlinks to advertisements. In a game-based embodiment, this display could be a game board comprised of graphical representations of hyperlinks as illustrated tiles.

While some embodiments can be implemented in fully functioning computers and computer systems, various embodiments are capable of being distributed as a computing product in a variety of forms and are capable of being applied regardless of the particular type of machine or computer-readable media used to actually effect the distribution.

At least some aspects disclosed can be embodied, at least in part, in software. That is, the techniques may be carried out in a computer system or other data processing system in response to its processor, such as a microprocessor, executing sequences of instructions contained in a memory, such as ROM, volatile RAM, non-volatile memory, cache or a remote storage device.

Routines executed to implement the embodiments may be implemented as part of an operating system, middleware, service delivery platform, SDK (Software Development Kit) component, web services, or other specific application, component, program, object, module or sequence of instructions referred to as “computer programs.” Invocation interfaces to these routines can be exposed to a software development community as an API (Application Programming Interface). The computer programs typically comprise one or more instructions set at various times in various memory and storage devices in a computer, and that, when read and executed by one or more processors in a computer, cause the computer to perform operations necessary to execute elements involving the various aspects.

A machine-readable medium car be used to store software and data which when executed by a data processing system causes the system to perform various methods. The executable software and data may be stored in various places including for example ROM, volatile RAM, non-volatile memory and/or cache. Portions of this software and/or data may be stored in any one of these storage devices. Further, the data and instructions can be obtained from centralized servers or peer-to-peer networks. Different portions of the data and instructions can be obtained from different centralized servers and/or peer-to-peer networks at different times and in different communication sessions or in a same communication session. The data and instructions can be obtained in entirety prior to the execution of the applications. Alternatively, portions of the data and instructions can be obtained dynamically, just in time, when needed for execution. Thus, it is not required that the data and instructions be on a machine-readable medium in entirety at a particular instance of time.

Examples of computer-readable media include but are not limited to recordable and non-recordable type media such as volatile and non-volatile memory devices, read-only memory (ROM), random access memory (RAM), flash memory devices, floppy and other removable disks, magnetic disk storage media, optical storage media (e.g., Compact Disk Read-Only Memory (CD ROMS), Digital Versatile Disks (DVDs), etc.), among others. In general, a machine-readable medium includes any mechanism that provides (e.g., stores) information in a form accessible by a machine (e.g., a computer, network device, personal digital assistant, manufacturing tool, any device with a set of one or more processors, etc.).

In various embodiments, hardwired circuitry may be used in combination with software instructions to implement the techniques. Thus, the techniques are neither limited to any specific combination of hardware circuitry and software nor to any particular source for the instructions executed by the data processing system.

Although some of the drawings illustrate a number of operations in a particular order, operations that are not order-dependent may be reordered and other operations may be combined or broken out. While some reordering or other groupings are specifically mentioned, others will be apparent to those of ordinary skill in the art and so do not present an exhaustive list of alternatives. Moreover, it should be recognized that the stages could be implemented in hardware, firmware, software or any combination thereof.

In the foregoing specification, the disclosure has been described with reference to specific exemplary embodiments thereof. It will be evident that various modifications may be made thereto without departing from the broader spirit and scope as set forth in the following claims. The specification and drawings are, accordingly, to be regarded in an illustrative sense rather than a restrictive sense.

What is claimed is:

1. A method comprising the steps of:
receiving, over a communications network, from a device associated with an end-user, a first advertisement query in the form of a request to play a game on a device;
selecting one or more advertisements stored in an advertisement database;
transmitting, over a communications network, a hyperlink to each of the one or more advertisements so selected, each said hyperlink to be displayed on an end-user's device in the form of a graphical object representing an advertiser within a game;
receiving from an end-user's device, over a communications network, a second advertisement query in the form of a request to a server to transmit to a device of an end-user for display thereon an advertisement containing a game token hyperlink;
transmitting, over a communications network, said advertisement containing a game token hyperlink for display on an end-user's device;
transmitting, over a communications network, an update to a game in response to an activation of a game token hyperlink in an advertisement.

2. The method of claim 1, in which hyperlinks to each of one or more selected advertisements are presented on a device of an end-user in the form of illustrated tiles laid out within a grid pattern on a game board, each of said illustrated tiles initially identifying a given advertiser or product option.

3. The method of claim 2, in which, during the course of playing a game, an end-user is required to activate at least one hyperlink by clicking on an illustrated tile.

4. The method of claim 2, in which, during the course of playing a game, an end-user is required to search for, find, and activate within an advertisement a game token hyperlink in order to progress in a game.

5. The method of claim 4, in which a game token hyperlink within an advertisement is presented as a graphical object representing a game token.

6. The method of claim 4, in which, during the course of playing a game, illustrated tiles can be rearranged as an update to a game when an end-user activates successfully a game token hyperlink.

7. The method of claim 2, in which, during the course of playing a game, a hyperlink to any of the one or more selected advertisements may be changed to a new hyperlink to a different advertisement represented by a different illustrated tile.

8. The method of claim 2, in which a game board includes a scoreboard to track a score of an end-user playing a game.

9. The method of claim 2, in which a game board includes one or more clickable buttons that an end-user may employ to carry out one or more game-related functions.

10. The method of claim 9, in which a game-related function carried out by a clickable button is to return to a display of an originating home page.

11. The method of claim 9, in which a game-related function carried out by a clickable button is to save a current configuration of a game.

12. The method of claim 9, in which a game-related function carried out by a clickable button is to advance play.

13. The method of claim 9, in which a game-related function carried out by a clickable button is to shuffle randomly a game board configuration.

14. The method of claim 13, in which, during the course of a game, any given shuffling of a game board configuration via a clickable button potentially can improve, diminish, or have no impact on a score of an end-user playing a game.

15. The method of claim 1, in which an end-user playing a game may compete with other end-users playing a game.

16. The method of claim 1, in which in, order to play a game, an end-user may be required to register by providing information about said end-user.

17. The method of claim 1, in which one or more of any advertisements selected are targeted to an end-user based on end-user preference data.

18. A machine readable media storing instructions that, when executed by a data processing system, cause the data processing system to perform a method comprising:
receiving, over a communications network, from a device associated with an end-user, a first advertisement query in the form of a request to play a game on a device;
selecting one or more advertisements stored in an advertisement database;
transmitting, over a communications network, a hyperlink to each of the one or more advertisements so selected, each said hyperlink to be displayed on an end-user's device in the form of a graphical object representing an advertiser within a game;
receiving from an end-user's device, over a communications network, a second advertisement query in the form of a request to a server to transmit to a device of an end-user for display thereon an advertisement containing a game token hyperlink;
transmitting, over a communications network, said advertisement containing a game token hyperlink for display on an end-user's device;
transmitting, over a communications network, an update to a game in response to an activation of a game token hyperlink in an advertisement.

19. A machine readable media storing instructions that, when executed by a end-user's device, cause the end-user's device to perform a method comprising:
receiving from a server, over a communications network, a hyperlink to each of one or more advertisements, each said hyperlink displayed on an end-user's device in the form of a graphical object representing an advertiser within a game;
receiving from a server, over a communications network, an advertisement, containing a game token hyperlink, displayed on an end-user's device;
receiving from a server, over a communications network, an updated game in response to the activation of said game token hyperlink in said advertisement.

20. A computer system comprising:
a memory; and
a processor coupled to the memory to:
receive, over a communications network, from a device associated with an end-user, a first advertisement query in the form of a request to play a game on a device;
select one or more advertisements stored in an advertisement database;
transmit, over a communications network, a hyperlink to each of the one or more advertisements so selected, each said hyperlink to be displayed on an end-user's device in the form of a graphical object representing an advertiser within a game;
receive from an end-user's device, over a communications network, a second advertisement query in the form of a request to a server to transmit to a device of an end-user for display thereon an advertisement containing a game token hyperlink;
transmit, over a communications network, said advertisement containing a game token hyperlink for display on an end-user's device;
transmit, over a communications network, an update to a game in response to an activation of a game token hyperlink in an advertisement.
